(19) United States
(12) Patent Application Publication
(10) Pub. No.: US 2007/0218870 A1
(43) Pub. Date: Sep. 20, 2007

(54) Radio communication apparatus and radio communication system

(76) Inventor: Tetsuya Satoh, Miyagi (JP)

Correspondence Address: DICKSTEIN SHAPIRO LLP, 1825 EYE STREET NW, Washington, DC, 20006-5403, US

(21) Appl. No.: 11/717,737

(22) Filed: Mar. 14, 2007

(30) Foreign Application Priority Data
Mar. 17, 2006 (JP) 2006-075027

(51) Int. Cl. H04M 11/04

(52) U.S. Cl. 455/404.2

(57) ABSTRACT

A radio communication apparatus includes a variable directivity antenna and a control unit and performs radio communication with another radio communication apparatus. The control unit calculates a position of the another radio communication apparatus by measuring a distance to the another radio communication apparatus and measuring directivity of the another radio communication apparatus by switching directivity of the wave of radio communication using the variable directivity antenna with a MEMS switch. Moreover, the control unit controls the output of the variable directivity antenna according to the calculated position of the another radio communication apparatus.

### CROSS-REFERENCE TO RELATED APPLICATIONS

The present document incorporates by reference the entire contents of Japanese priority document, 2006-075027 filed in Japan on Mar. 17, 2006.

### BACKGROUND OF THE INVENTION

1. Field of the Invention

The present invention relates to a radio communication apparatus and a radio communication system, and, more particularly to a radio communication apparatus and a radio communication system that obtain position information of another communication apparatus.

2. Description of the Related Art

Conventionally, a technique of obtaining a position of a mobile station using at least three base stations, preferably four or more base stations, is known (Japanese Patent Application Laid-open No. 2004-301850).

There is also known a technique of carrying out an electronic conference through data communications between plural clients and a server, by displaying characters on a large display screen (Japanese Patent Application Laid-open No. 2003-281101).

There is also known a technique of carrying out an electronic meeting through data transactions between plural terminals and a web server, by connecting these terminals to the web server via the Internet (Japanese Patent Application Laid-open No. 2004-240577).

There is also known a technique of obtaining position information of the other radio communication apparatus, based on a global positioning system (GPS) and an exclusive measuring device.

However, when a GPS and an exclusive measuring device are introduced to obtain a position of the other radio communication apparatus in a conventional office supporting system such as an electronic meeting system, cost of introducing the GPS and the exclusive measuring device increases. According to a technique of WiMedia (MBOA) capable of measuring a distance from the other radio communication apparatus, a position of another communication apparatus can be known. However, according to the technique of WiMedia (MBOA), directivity of waves cannot be controlled. Therefore, positional relationship of two or three radio communication apparatuses cannot be obtained easily, and four or more radio communication apparatuses are necessary.

Specifically, when two or three radio communication apparatuses are used, a plane surface cannot be specified, and it is difficult to obtain position information. For example, when there are two radio communication apparatuses that can measure a distance, a distance between the self station and the other station can be specified. However, a position of the other station cannot be specified and it can be only known that the other station is somewhere around the self station on the spherical surface. Even when a plane surface is specified in advance, it can be only known that the other station is somewhere around the self station on a circle, and the position cannot be specified.

FIG. 12 is a schematic for explaining whether two radio stations can obtain position information according to a conventional technique. A distance between a first radio station 51 and a second radio station 52 and a distance between the first radio station 51 and a third radio station 53 can be measured based on a function provided by WiMedia (MBOA). However, a direction from the first radio station 51 to the second and third radio stations 52 and 53, respectively, cannot be specified.

FIG. 13A is a schematic for explaining whether three radio stations can obtain position information according to a conventional technique. A distance between a first radio station 61 and a second radio station 62, a distance between the first radio station 61 and a third radio station, and a distance between the second radio station 62 and the third radio station 63 can be measured based on a function provided by WiMedia (MBOA). However, a direction from the first radio station 61 to the second radio station 62 and a direction from the first radio station 61 to the third radio station 63 can be either as shown in FIG. 13A or FIG. 13B, and it is not possible to specify which one of the positional relationships is correct.

### SUMMARY OF THE INVENTION

It is an object of the present invention to at least partially solve the problems in the conventional technology.

According to an aspect of the present invention, a radio communication apparatus includes a radio communication unit that carries out radio communication with another radio communication apparatus; a distance measuring unit that measures a distance between the radio communication unit and the another radio communication apparatus; a directivity changing unit that changes directivity of a wave of radio communication by the radio communication unit; an azimuth measuring unit that measures azimuth of the another radio communication apparatus by switching the directivity of a wave by the directivity changing unit; a position calculating unit that calculates a position of the another radio communication apparatus based on a distance measured by the distance measuring unit and azimuth measured by the azimuth measuring unit; and a communication output control unit that controls an output of the radio communication unit according to a position of the another radio communication apparatus calculated by the position calculating unit.

According to another aspect of the present invention, a radio communication system including a plurality of radio communication apparatuses, wherein at least a first radio communication apparatus among the radio communication apparatuses includes a radio communication unit that carries out radio communication with a second radio communication apparatus among the radio communication apparatuses; a distance measuring unit that measures a distance between the radio communication unit and the second radio communication apparatus; a directivity changing unit that changes directivity of a wave of radio communication by the radio communication unit; an azimuth measuring unit that measures azimuth of the second radio communication apparatus by switching the directivity of a wave by the directivity changing unit; a position calculating unit that calculates a position of the second radio communication apparatus based on a distance measured by the distance measuring unit and azimuth measured by the azimuth measuring unit; and a communication output control unit that controls an output of the radio communication unit according to a position of the second radio communication apparatus calculated by the position calculating unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a configuration of a radio communication apparatus according to one embodiment of the present invention;

FIG. 2A is a perspective view of a directivity antenna according to the embodiment;

FIG. 2B is a cross-sectional view of the directivity antenna according to the embodiment;

FIG. 3A is a schematic for explaining a position obtaining procedure of a radio station including the radio communication apparatus according to the embodiment;

FIG. 3B is a schematic for explaining a position obtaining procedure of a radio station including the radio communication apparatus according to the embodiment;

FIG. 4 is a sequence diagram for explaining a position obtaining procedure of a radio station including the radio communication apparatus according to the embodiment;

FIG. 5 depicts a distance calculating model used in a position obtaining procedure of a radio station including the radio communication apparatus according to the embodiment;

FIG. 6 is a schematic for explaining a position obtaining procedure of a radio station including the radio communication apparatus according to the embodiment;

FIG. 7 is a sequence diagram for explaining one example of a position obtaining procedure of a radio station including the radio communication apparatus according to the embodiment;

FIG. 8 is a sequence diagram for explaining another example of a position obtaining procedure of a radio station including the radio communication apparatus according to the embodiment;

FIG. 9 is a sequence diagram for explaining still another example of a position obtaining procedure of a radio station including the radio communication apparatus according to the embodiment;

FIG. 10 is a configuration diagram of an example of an application of the radio communication apparatus according to the embodiment to an office supporting system;

FIG. 11 depicts an application screen executed by the office supporting system;

FIG. 12 is a schematic for explaining obtaining of a position according to a conventional technique; and

FIG. 13 is another schematic for explaining the obtaining of a position according to the conventional technique.

### DETAILED DESCRIPTION OF THE PREFERRED EMBODIMENTS

Exemplary embodiments of the present invention will be explained below in detail with reference to the accompanying drawings.

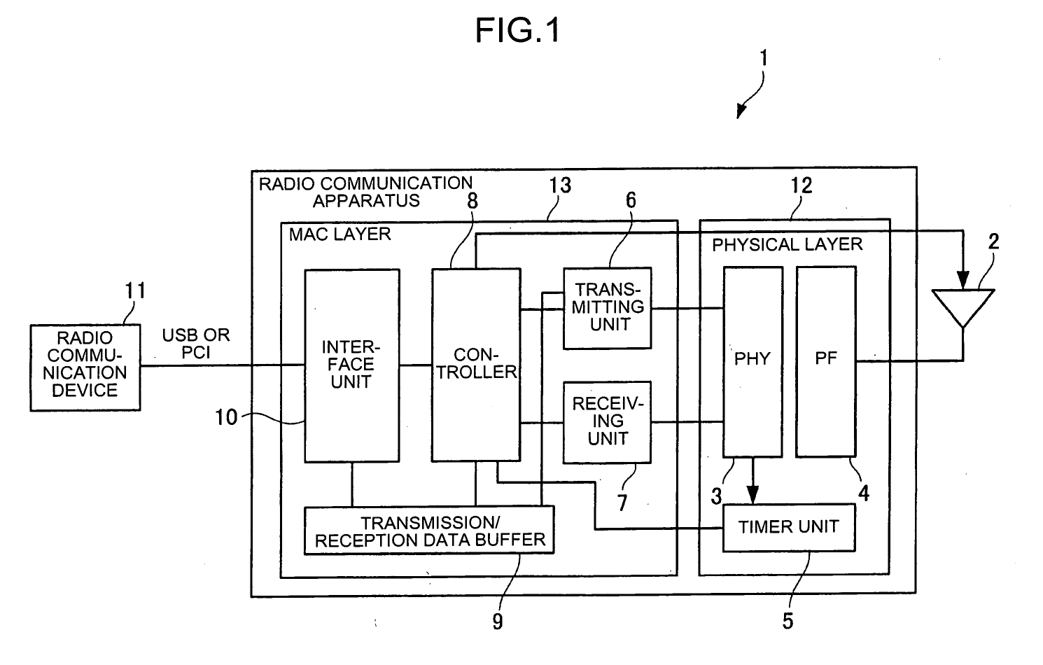

FIG. 1 is a block diagram of a configuration of a radio communication apparatus according to one embodiment of the present invention. In this embodiment, the radio communication apparatus includes a variable directivity antenna described later, thereby obtaining position information using two radio communication apparatuses.

A radio communication apparatus 1 includes a variable directivity antenna 2, a coding and decoding unit 3 (described as PHY in FIG. 1), and a radio frequency unit 4 (described as RF in FIG. 1). The variable directivity antenna 2, the coding and decoding unit 3, and the radio frequency unit 4 constitute a physical layer 12 in the radio communication apparatus 1.

The radio communication apparatus 1 includes a transmitting unit 6, a receiving unit 7, a controller 8, a transmission/reception data buffer 9, and an interface unit 10. The transmitting unit 6, the receiving unit 7, the controller 8, the transmission/reception data buffer 9, and the interface unit 10 constitute a media access control (MAC) layer 13 in the radio communication apparatus 1.

A radio communication device 11 such as a personal computer (PC) is connected to the interface unit 10. When the radio communication apparatus 1 carries out a radio transmission, data transmitted from the radio communication device 11 is once stored in the transmission/reception data buffer 9 via the interface unit 10. The radio frequency unit 4 processes the data stored in the transmission/reception data buffer 9, based on an instruction from the controller 8, and radio transmits the processed data from the variable directivity antenna 2. On the other hand, when the radio communication apparatus 1 radio receives data, the radio frequency unit 4 processes the data radio-received by the variable directivity antenna 2, and once stores the processed data in the transmission/reception data buffer 9 via the receiving unit 7. The data once stored in the transmission/reception data buffer 9 is transmitted to the radio communication device 11 via the interface unit 10 based on an instruction from the controller 8. The controller 8 transmits a signal for ON and OFF controlling an antenna switch (not shown), to the variable directivity antenna 2, thereby electrically controlling the directivity of the variable directivity antenna 2. Therefore, directivity can be changed very quickly.

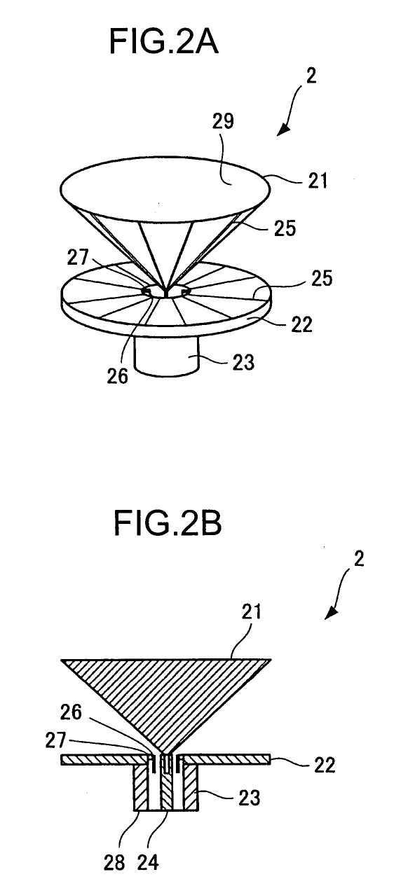

A detailed configuration of the variable directivity antenna 2 is explained next with reference to FIG. 2A and FIG. 2B. FIG. 2A is a schematic perspective view of the variable directivity antenna 2, and FIG. 2B is a schematic cross-sectional view of the variable directivity antenna 2. The variable directivity antenna 2 can change the directivity based on a set of antenna and a power supply circuit.

The variable directivity antenna 2 is supplied with power from a coaxial line 23, and has a bottom board 22 and a conical upper electrode 21 on the bottom board 22, thereby forming an omnidirectional discone antenna 29. A groove 25 radially extending from the center of the discone antenna 29 is formed on the upper electrode 21 and the bottom board 22, respectively of the discone antenna 29.

Floating conductor plates 26 made of metal parallel with a signal line 24 of the coaxial line 23 and a ground conductor 28 are embedded in a portion near a connection part between the coaxial line 23 and the discone antenna 29, in four directions at an interval of 90 degrees. The floating conductor plates 26 and the ground conductor 28 are connected together with plural MEMS switches 27. The MEMS switch 27 is a switch using a technique of Micro Electro Mechanical Systems (MEMS). The MEMS switch 27 is used to electrically control ON and OFF states of the variable directivity antenna 2, using a control electrode (not shown) from the outside of the variable directivity antenna 2. When all MEMS switches 27 are set to OFF, there is no disturbance in the electric field distribution of the coaxial line 23, and a radiation pattern of the discone antenna 29 remains omnidirectional. Directivity of the discone antenna 29 can be changed by changing over the direction of the MEMES switch 27 which is set ON, and an operation frequency band can be controlled by changing capacitance. The groove 25 provided on the upper electrode 21 and the bottom board 22 makes it easy to radiate an electric field while maintaining nonuniformity of the radiation electric field distribution. Therefore, the variable directivity antenna 2 can change over the directivity independently of plural frequencies, while keeping a size equivalent to that of the normal omnidirectional antenna. Because the variable directivity antenna 2 can electronically change over directivity with the MEMS switch 27, the MEMS switch 27 can also change over directivity in a very short time of a few microseconds.

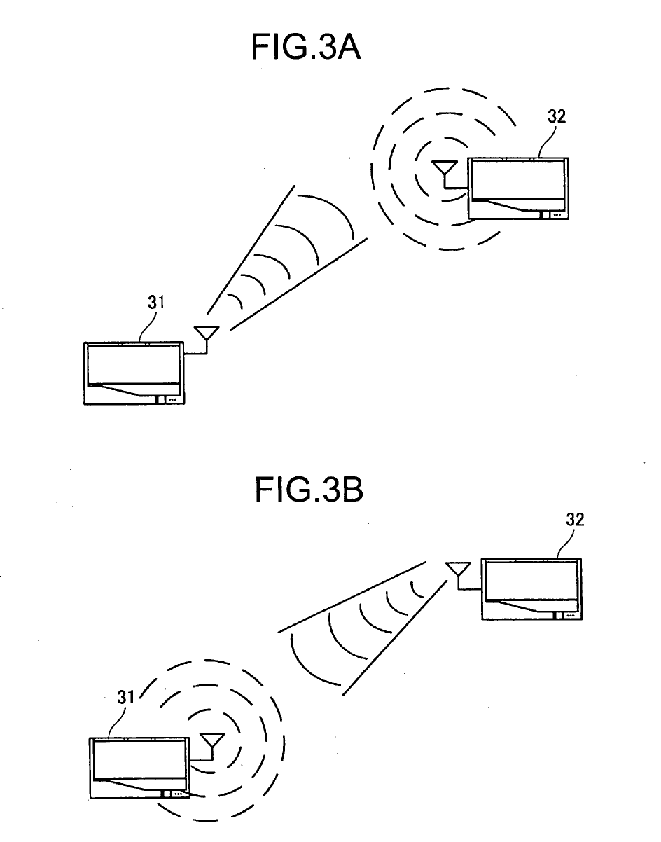

A radio communication system including the above radio communication apparatus 1 is explained next. In the present embodiment, the radio communication system includes a first radio station 31 and a second radio station 32. FIG. 3A depicts a state that the first radio station 31 includes the radio communication apparatus 1, and FIG. 3B depicts a state that the second radio station 32 includes the radio communication apparatus 1.

When the first radio station 31 includes the radio communication apparatus 1 as shown in FIG. 3A, the first radio station 31 can scan radios from the second radio station 32 in a narrow range. In this case, the first radio station 31 can specify a direction of the second radio station 32 by changing over between the MEMS switch 27. A distance between the first radio station 31 and the second radio station 32 can be measured in a distance measuring procedure of WiMedia (MBOA) described later. Similarly, when the second radio station 32 shown in FIG. 3B includes the radio communication apparatus 1, the second radio station 32 can scan radios from the first radio station 31 in a narrow range. In this case, the second radio station 32 can specify a direction of the first radio station 31 by changing over between the MEMS switch 27. A distance between the first radio station 31 and the second radio station 32 can be measured in the distance measuring procedure of WiMedia (MBOA).

WiMedia Alliance (MBOA) is a name of a radio community, and is defined to use the MAC specification of the WiMedia system in the Wireless USB (WUSB) technique or its higher protocol. The WUSB is a radio edition of USB. In other words, in this specification, a physical layer of the existing USB protocol is expressed by radio. The radio technique employs Ultra Wideband (UWB) for carrying out communication using a wide band of 7.5 gigahertz as a maximum. In the UWB, two physical layers of “MBOA UWB PHY” and “MBOA MAC” and a buffer layer “WiMedia” serving as an intermediary of the application operating on the physical layers are defined. With this arrangement, support of various kinds of media such as WUSB and transmission control protocol/Internet protocol (TCP/IP) stack is carried out, in addition to normal communication of Wireless Fidelity (Wi-Fi). The UWB is a radio technique for transferring data between household electronic appliances, personal computer peripheral units, and mobile apparatuses in a short distance. While achieving a high-speed radio transmission, power consumption can be decreased. The UWB is suitable for a transfer of high-definition image multimedia contents. For example, a family video can be transmitted from a digital video recorder to a high-definition television in a living room, or presentation data can be transferred from a notebook personal computer to a projector in a meeting room.

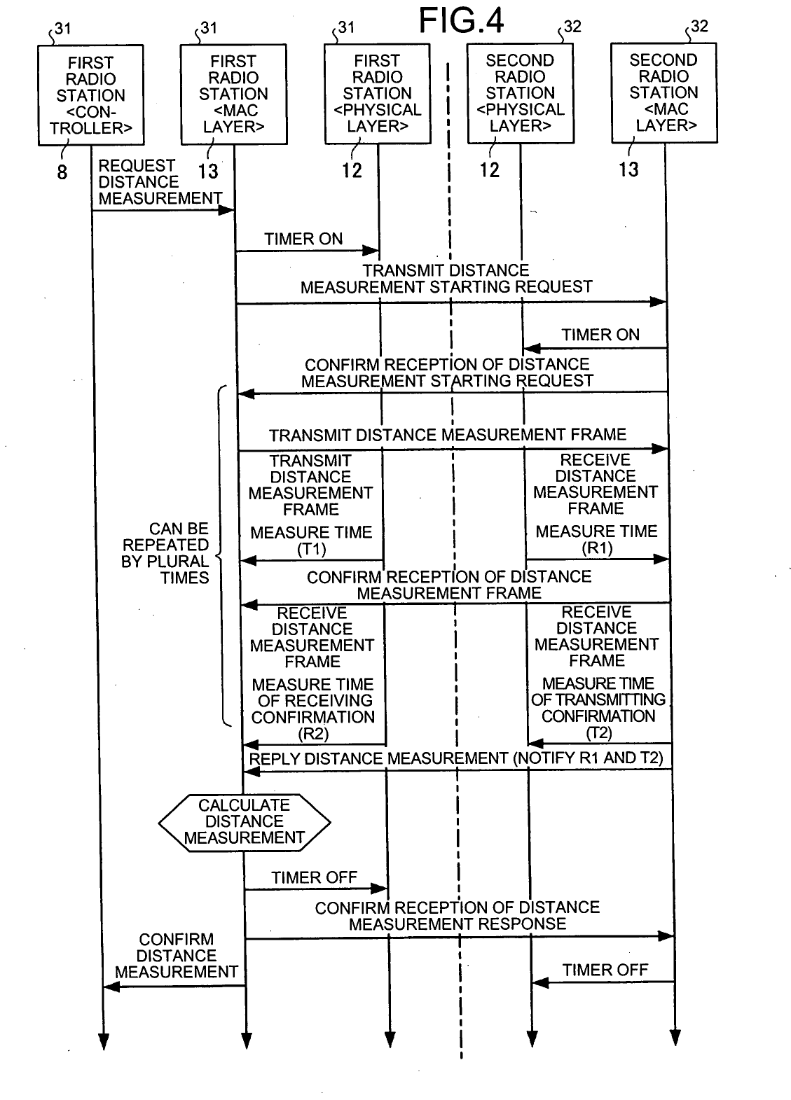

A distance measuring procedure using the WiMedia (MBOA) technique of the radio communication apparatus 1 is explained next. FIG. 4 explains the distance measuring procedure using the WiMedia (MBOA) technique. In the following explanations, both the first radio station 31 and the second radio station 32 include the radio communication apparatus 1.

First, a preparation for measuring a distance is explained. When the controller 8 of the first radio station 31 transmits a distance measuring request to the MAC layer 13 of the first radio station 31, the MAC layer 13 of the first radio station turns on a timer of a timer unit 5 (see FIG. 1) of the physical layer 12 of the first radio station 31, to measure time.

The MAC layer 13 of the first radio station 31 transmits a distance measurement starting request to the MAC layer 13 of the second radio station 32. The MAC layer 13 of the second radio station 32 turns on the timer of the timer unit 5 of the physical layer 12 of the second radio station 32, to measure time. The MAC layer 13 of the second radio station 32 transmits a reception confirmation of the distance measurement starting request to the MAC layer 13 of the first radio station 31.

A transmission-time measurement procedure is explained next. The MAC layer 13 of the first radio station 31 transmits a distance measurement frame to the MAC layer 13 of the second radio station 32. When the MAC layer 13 of the first radio station 31 transmits the distance measurement frame, and measures transmission. In this case, transmission time of each frame is recorded in the physical layer 12 of the first radio station 31. At a distance measurement frame transmission time (T1), a timer value is automatically recorded in the timer unit 5 of the physical layer 12 of the first radio station 31. After the frame is transmitted, the MAC layer 13 of the first radio station 31 reads a value recorded in the physical layer 12 of the first radio station 31.

Upon receiving the distance measurement frame, the MAC layer 13 of the second radio station 32 measures a reception time. In this case, reception time of each frame is recorded in the physical layer 12 of the second radio station 32. At a distance measurement frame reception time (R1), a timer value is automatically recorded in the timer unit 5 of the physical layer 12 of the second radio station 32, and the MAC layer 13 of the second radio station 32 reads a value recorded in the physical layer 12 of the second radio station 32.

The MAC layer 13 of the second radio station 32 transmits a reception confirmation of the distance measurement frame to the MAC layer 13 of the first radio station 31 as a transmission station.

Upon transmitting a reception confirmation, the MAC layer 13 of the second radio station 32 measures transmission time of the reception confirmation. A reception time of each frame is recorded in the physical layer 12 of the second radio station 32. At a distance measurement frame reception time (T2), a timer value is automatically recorded in the timer unit 5 of the physical layer 12 of the radio station 32, and the MAC layer 13 of the second radio station 32 reads a value recorded in the physical layer 12 of the second radio station 32.

Upon receiving a reception confirmation of the distance measurement frame from the MAC layer 13 of the second radio station 32, the physical layer 12 of the first radio station 31 measures reception time of the reception confirmation. In this case, reception time of each frame is recorded in the physical layer 12 of the first radio station 31. At a distance measurement frame reception confirmation time (R2), a timer value is automatically recorded in the timer unit 5 of the physical layer 12 of the first radio station 31, and the MAC layer 13 of the first radio station 31 reads a value recorded in the physical layer.

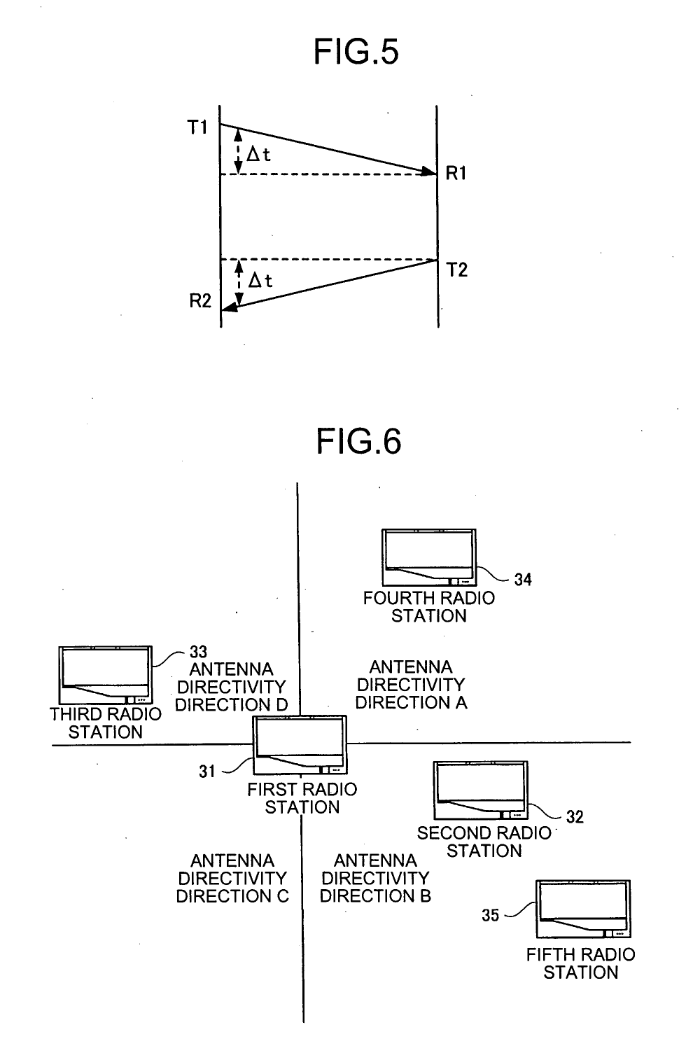

A distance measurement calculation carried out by the first radio station 31 is explained next. The MAC layer 13 of the first radio station 31 calculates a transmission time (period) Δt based on a distance measurement calculation model shown in FIG. 5, using the transmission time and the reception time measured as described above. The transmission time (period) Δt is calculated from the expression of the transmission time (period) Δt[nanosecond]={(T1−R2)−(R1−T2)}/2. A logical value 1 nanosecond=28 centimeters.

A response of distance measurement is explained next. The MAC layer 13 of the second radio station 32 transmits a distance measurement response of a distance calculated by the above distance measurement calculation, to the MAC layer 13 of the first radio station 31. The MAC layer 13 of the first radio station 31 turns off the timer of the timer unit 5 of the physical layer 12 of the first radio station 31. The MAC layer 13 of the first radio station 31 transmits a reception confirmation of a distance measurement response, to the MAC layer 13 of the second radio station 32. The MAC layer 13 of the second radio station 32 turns off the timer of the timer unit 5 of the physical layer 12 of the second radio station 32. The MAC layer 13 of the first radio station 31 transmits a distance measurement confirmation to the controller 8 of the first radio station 31. The measurement of a distance between the first radio station 31 and the second radio station 32 is completed in the above procedure.

It is not necessary that both the first radio station 31 and the second radio station 32 include the radio communication apparatus 1. When either one of the first radio station 31 and the second radio station 32 includes the radio communication apparatus 1 mounted with the variable directivity antenna 2, a distance between the radio stations can be measured in the distance measurement procedure prescribed in WiMedia (MBOA). Therefore, position information can be obtained between two radio stations. In the case of three or more radio stations, when either one of these radio stations includes the radio communication apparatus 1 mounted with the variable directivity antenna 2, a distance between two radio stations can be measured in a distance measurement procedure similar to the procedure explained for the two radio stations.

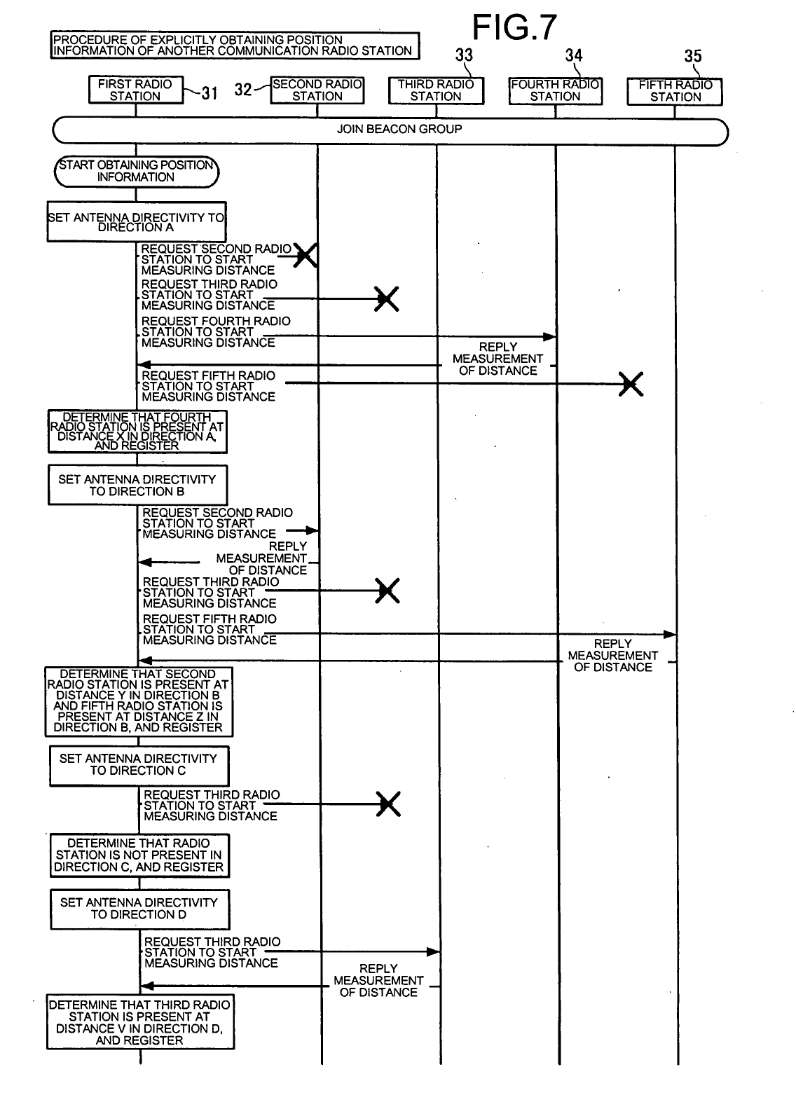

The procedure of obtaining position information is explained next in further detail. FIG. 6 is one example of a position relationship of radio stations according to the present embodiment. The first radio station 31 includes the radio communication apparatus 1 having the variable directivity antenna 2, and can change directivity in four areas of directivity A, directivity B, directivity C, and directivity D, with a difference of 90 degrees between the directivities, as described above. The second radio station 32, a third radio station 33, a fourth radio station 34, and a fifth radio station 35 do not include the variable directivity antenna 2. When there are many areas of directivities, position information can be obtained in higher precision.

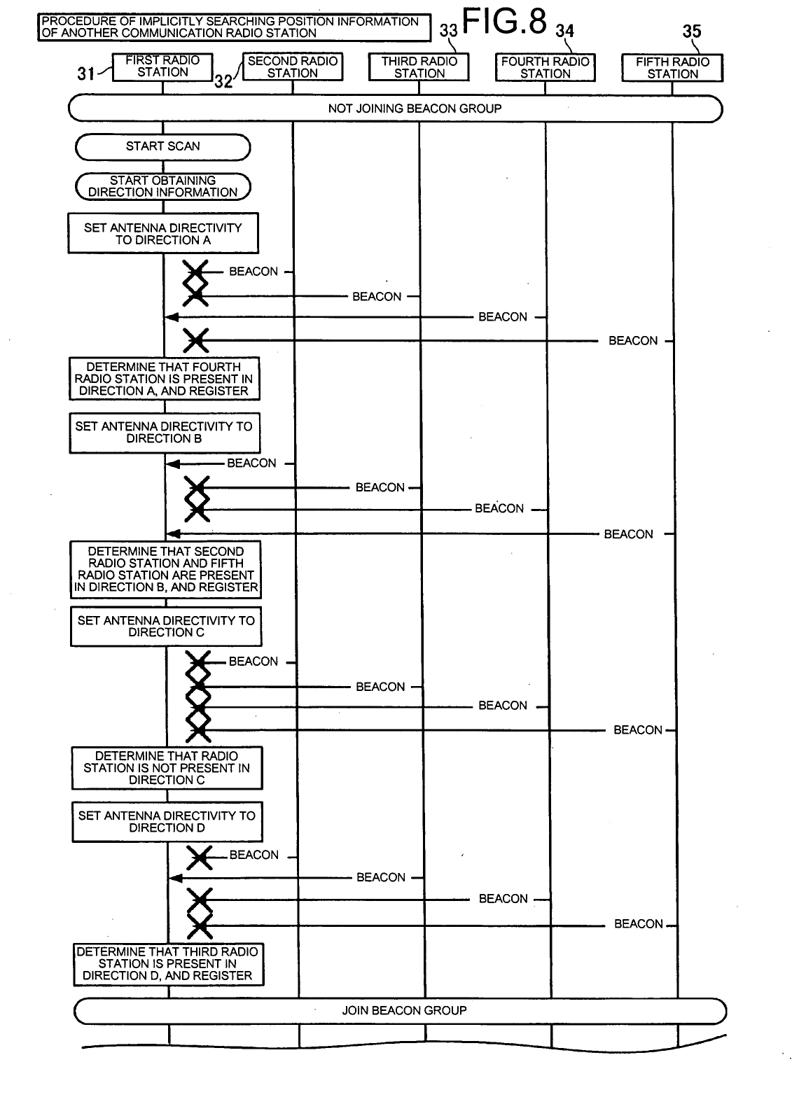

A procedure of obtaining position information of the second radio station 32, the third radio station 33, the fourth radio station 34, and the fifth radio station 35 by the first radio station 31 is explained next. FIG. 7 is a sequence diagram of one example of the procedure of obtaining position information. First, the first radio station 31 sets directivity of the variable directivity antenna 2 to all directions, and joins Beacon Group along the procedure of WiMedia (MBOA). When the joining Beacon Group is completed, basic information (such as a device address and a MAC address) of the second radio station 32, the third radio station 33, the fourth radio station 34, and the fifth radio station 35 can be obtained from the received beacon. The first radio station 31 selects a radio station of which position information is to be obtained, from the basic information. In the present embodiment, a procedure of obtaining position information of all the second radio station 32, the third radio station 33, the fourth radio station 34, and the fifth radio station 35 is explained. Alternatively, position information of only a specific selected radio station can be obtained. Next, directivity of the variable directivity antenna 2 is set to the direction A to make it possible to transmit a radio to and receive a radio from the area of the direction A. In this state, a distance measurement starting request is sequentially transmitted to the second radio station 32, the third radio station 33, the fourth radio station 34, and the fifth radio station 35. In the present embodiment, because the fourth radio station 34 is present in the area of the direction A, a distance measurement response is returned from only the fourth radio station 34. Meanwhile, the first radio station 31 calculates a distance between the self radio station 31 and the fourth radio station 34 in the above distance measurement procedure. For example, when a calculation result is a distance X, it can be determined that the fourth radio station 34 is present at the distance X in the direction A. This information is stored in the memory within the controller 8. Next, directivity of the variable directivity antenna 2 is set to the direction B. In a procedure similar to that of calculating a distance in the direction A, it can be determined that the second radio station 32 is present at a distance Y in the direction B and, the fifth radio station 35 is present at a distance Z in the direction B. This information is stored in the memory. A similar procedure is carried out in the direction C and the direction D. It can be determined that the third radio station 53 is present at a distance V in the direction D, and this information is stored in the memory. Position information of all the radio stations present around the first radio station 31 has been obtained in the above operation, and this information can be used in a higher application.

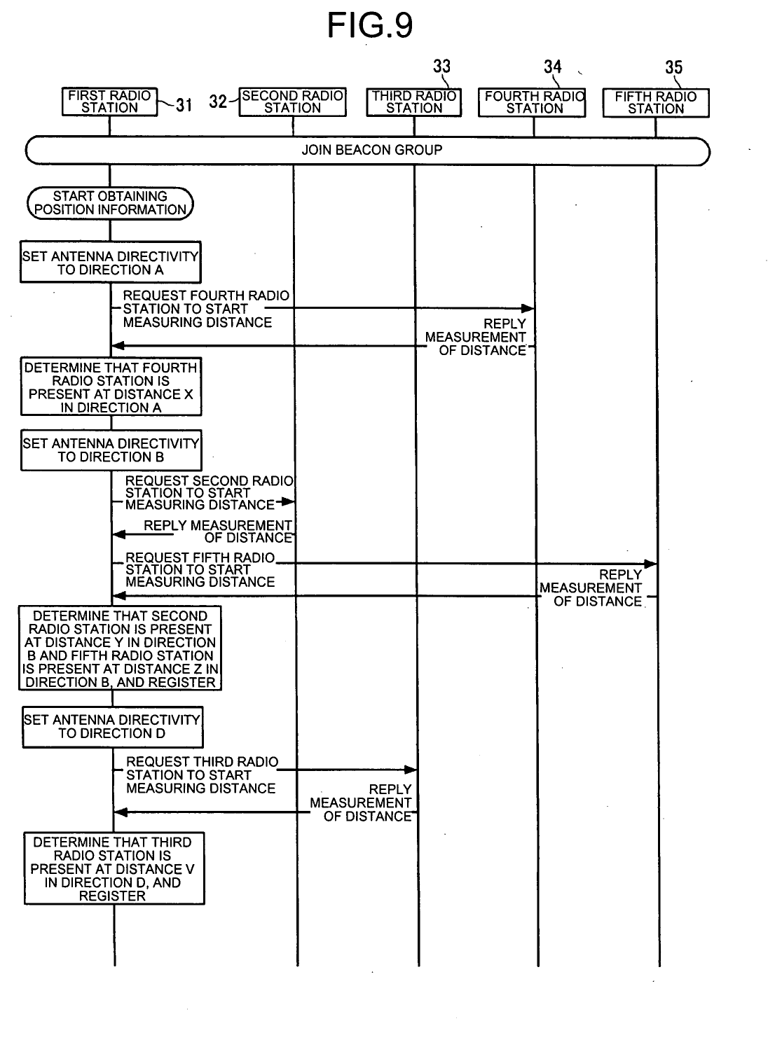

Another example of a procedure of obtaining position information is explained with reference to sequence diagrams shown in FIG. 8 and FIG. 9. While the sequence diagram shown in FIG. 7 is the one for explicitly obtaining position information of the radio station of another communication party, the sequence diagrams shown in FIG. 8 and FIG. 9 are the ones for implicitly searching a direction of the radio station of the another communication party. In FIG. 8 and FIG. 9, a radio station scans each azimuth with the variable directivity antenna 2, in a state that the radio station does not join Beacon Group, thereby determining presence of a radio station and identifying the radio station. Thereafter, the radio station joins Beacon Group, and sequentially switches the directivity of the variable directivity antenna 2 to an azimuth in which a radio station is present. The radio station obtains a distance from the self radio station to the radio station present in this azimuth. In this case, the first radio base station 31 can transmit a distance measurement request to a desired radio station, using a wave in the controlled directivity. Therefore, a risk that the wave of the distance measurement request is monitored by a radio station in other direction can be reduced, and security is improved.

A radio station is movable in general, and is not always at the same position. Therefore, it is preferable that position information is updated by carrying out the position-information obtaining procedures shown in FIG. 8 and FIG. 9 at a constant time interval.

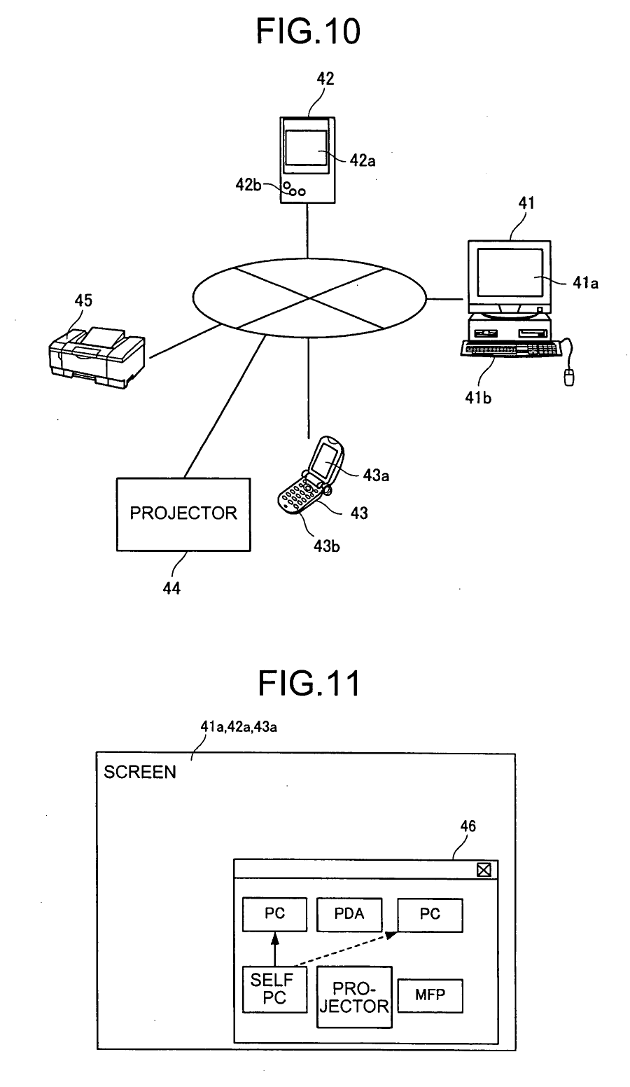

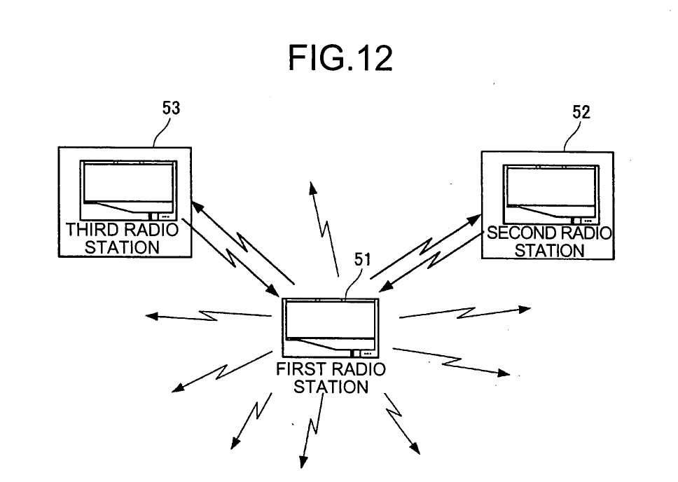

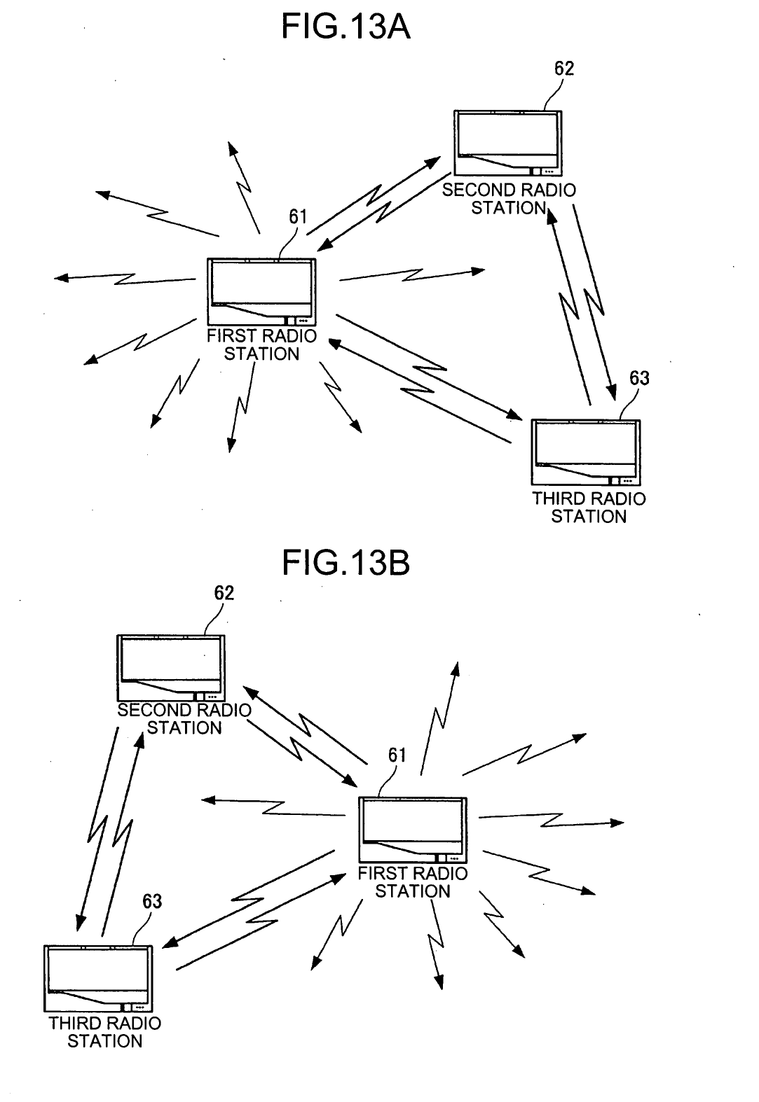

An application of the above radio communication system to an office supporting system that handles information between plural different information apparatuses by radio communication is explained next. An office supporting system shown in FIG. 10 is used for plural users in an office to carry out a meeting or exchange information using radio communication apparatuses (radio stations). The office supporting system according to the present embodiment includes a personal computer (PC) 41, personal digital assistants (PDA) 42, a portable telephone 43, a projector 44, and a printer 45. The office supporting system can also include a digital multi function peripheral (MFP), in addition to the above elements.

In the office supporting system shown in FIG. 10 and FIG. 11, the PCA 41, the PDA 42, and the portable telephone 43 include the radio communication apparatus 1 having the variable directivity antenna 2, and also include display units 41a, 42a, 43a. The application described below is executed to the display units 41a, 42a, 43a. With this arrangement, peripheral radio communication apparatuses (radio stations) are detected, positions of the peripheral radio communication apparatuses (radio stations) are obtained, and data is exchanged, in the procedure shown in the sequence diagrams in FIG. 7, FIG. 8, and FIG. 9. The PCA 41, the PDA 42, and the portable telephone 43 include operation input units 41b, 42b, 43b including buttons, keyboards, etc., respectively. Based on the operation input from the operation input units 41b, 42b, 43b, data of the self apparatus can be transmitted to the printer 45, and characters can be printed with the printer 45.

The operation of the application is explained next with reference to FIG. 11. FIG. 11 is one example of an application screen 46 displayed in the display units 41a, 42a, 43a of the PCA 41, the PDA 42, and the portable telephone 43, respectively. When a user of the PCA 41, the PDA 42, and the portable telephone 43 executes the application, the PCA 41, the PDA 42, and the portable telephone 43 having the radio communication apparatus 1 scans or monitors a wave, and determines presence or absence of a peripheral apparatus. When a presence of a peripheral apparatus is confirmed, a beacon transmission is started, and the user joins communication. At this time, a distance between the radio communication apparatus 1 and the peripheral is not known. Therefore, transmission is started at maximum power. A distance between the radio communication apparatus 1 and each peripheral apparatus is then measured, and communication is carried out at a transmission output matching a distance from each peripheral apparatus. For example, when communication is to be carried out with a PC nearest the self PC as shown in FIG. 11, the self PC communicates with this nearest PC at a transmission output which matches a distance from the nearest PC. With this arrangement, the self PC can communicate with a desired peripheral apparatus by matching a distance from this peripheral apparatus and the self PC.

The application screen 46 showing connectable peripheral apparatuses and their position information are displayed by a graphical use interface (GUI), on the PCA 41, the PDA 42, and the portable telephone 43 that execute the application.

The user of the PCA 41, the PDA 42, and the portable telephone 43 carries out drag-and-drops of files to be transmitted and received with a mouse on the application screen 46 displayed in the display units 41a, 42a, 43a, thereby transmitting and receiving data to and from the peripheral apparatuses. The user can also print out files from the PC 41 to the printer 45 by dragging and dropping the files on the application screen 46. The user can also distribute presentation files to be projected from the PC 41 to the projector 44 by dragging and dropping the files.

As described above, in the radio communication apparatus 1 and the radio communication system according to the present embodiment, a distance from another communication apparatus is measured using the function of WiMedia (MBOA), and azimuth of the another communication apparatus is measured by switching the directivity of the wave with the variable directivity antenna 2, thereby obtaining a position of the another communication apparatus. Therefore, positional relationship of two radio communication apparatuses can be obtained without via a server, when only two radio communication apparatuses are present in the radio communication system. Because the output of radio communication is controlled based on a position of the another communication apparatus, adjacent other radio apparatuses can be prevented from being affected by the output, and power consumption can be decreased.

When the radio communication apparatus according to the present embodiment is applied to the office supporting system, positional relationship of two radio communication apparatuses can be obtained without via a server, when only two radio communication apparatuses are present in the radio communication system. Further, the user can transfer and output files to the other apparatus such as the printer 45 of which position is displayed in the display units 41a, 42a, 43a, by a simple operation of drag-and-drop with the operation input units 41b, 42b, 43b such as buttons, a keyboard, and a mouse. Therefore, the infrastructure cost and space can be decreased as compared to the cost and space according to the conventional technique, which requires infrastructure such as a server and a cable network.

Thus, a communication apparatus obtains a position of another communication apparatus by measuring a distance between the another communication apparatus and the self apparatus, and by measuring azimuth of the another communication apparatus by switching the directivity of the wave. Therefore, position information can be obtained between two radio communication apparatuses without via a server. Because the output of radio communication is controlled based on a position of the another communication apparatus, adjacent other radio apparatuses can be prevented from being affected by the output, and power consumption can be decreased.

Moreover, positional relationship of two radio communication apparatuses can be obtained without via a server, when only two radio communication apparatuses are present. Further, the user can transfer and output files to the other apparatus such as the printer by a simple operation with the operation input unit. Therefore, the infrastructure cost and space can be decreased as compared to the cost and space of the conventional technique, which requires infrastructure such as a server and a cable network.

According to an aspect of the present invention, a radio communication apparatus and a radio communication system capable of obtaining positional relationship of two radio communication apparatuses without via a server can be provided.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A radio communication apparatus comprising:
a radio communication unit that carries out radio communication with another radio communication apparatus;
a distance measuring unit that measures a distance between the radio communication unit and the another radio communication apparatus;
a directivity changing unit that changes directivity of a wave of radio communication by the radio communication unit;
an azimuth measuring unit that measures azimuth of the another radio communication apparatus by switching the directivity of a wave by the directivity changing unit;
a position calculating unit that calculates a position of the another radio communication apparatus based on a distance measured by the distance measuring unit and azimuth measured by the azimuth measuring unit; and
a communication output control unit that controls an output of the radio communication unit according to a position of the another radio communication apparatus calculated by the position calculating unit.

2. A radio communication system including a plurality of radio communication apparatuses, wherein at least a first radio communication apparatus among the radio communication apparatuses includes
a radio communication unit that carries out radio communication with a second radio communication apparatus among the radio communication apparatuses;
a distance measuring unit that measures a distance between the radio communication unit and the second radio communication apparatus;
a directivity changing unit that changes directivity of a wave of radio communication by the radio communication unit;
an azimuth measuring unit that measures azimuth of the second radio communication apparatus by switching the directivity of a wave by the directivity changing unit;
a position calculating unit that calculates a position of the second radio communication apparatus based on a distance measured by the distance measuring unit and azimuth measured by the azimuth measuring unit; and
a communication output control unit that controls an output of the radio communication unit according to a position of the second radio communication apparatus calculated by the position calculating unit.

3. The radio communication system according to claim 2, further comprising:
a display unit that displays a position of the second radio communication apparatus calculated by the position calculating unit; and
an operation input unit that receives input of an instruction relating to an operation to be performed with respect to the second radio communication apparatus.
